(19) United States
(12) Patent Application Publication
(10) Pub. No.: US 2018/0025413 A1
(43) Pub. Date: Jan. 25, 2018

(54) ENTERPRISE DATA MARKETPLACE SYSTEM AND METHOD

(71) Applicants: Alex Rosenthal, Syosset, NY (US); Daniel Johnson, Slingerlands, NY (US); Jennifer Dieter, Allentown, PA (US); Wang Cheung, Astoria, NY (US); Ashutosh Khandekar, North Brunswick, NJ (US); Prathamesh Jagtap, Jersey City, NJ (US)

(72) Inventors: Alex Rosenthal, Syosset, NY (US); Daniel Johnson, Slingerlands, NY (US); Jennifer Dieter, Allentown, PA (US); Wang Cheung, Astoria, NY (US); Ashutosh Khandekar, North Brunswick, NJ (US); Prathamesh Jagtap, Jersey City, NJ (US)

(73) Assignee: Guardian Life Insurance Company of America, New York, NY (US)

(21) Appl. No.: 15/637,758

(22) Filed: Jun. 29, 2017

Related U.S. Application Data
(60) Provisional application No. 62/356,809, filed on Jun. 30, 2016.

(51) Int. Cl. G06Q 30/06

(52) U.S. Cl. CPC G06Q 30/0641; G06Q 30/0631; G06Q 30/0613; G06Q 30/0623

(57) ABSTRACT

A system and method for a centralized data asset marketplace including a single network or cloud platform environment for the sharing and distribution of data assets, wherein the platform is public or private; multiple user interfaces, wherein the user interfaces include a home page, a data asset detail interface, a shopping cart interface, a user data section interface and an administrative section interface; and data assets, wherein the data assets are at least one of a report, a file download, a data service, a micro service or an applet. Managing the data assets via a centralized system includes registering of data assets, wherein the registering of the data assets includes registering meta data of the data assets; accessing and execution of data assets; searching for data assets, wherein the searching can be via a pre-configured search or custom created search queues; sharing of data assets, wherein the sharing of the data assets can be done for the corresponding meta data or of actual results of the data asset; checking out data assets, wherein checking out of the data assets includes adding the assets to a shopping cart; and authorization for selective execution of the data assets.

This application claims priority to U.S. Provisional Patent Application No. 62/356,809 filed Jun. 30, 2016, entitled “DATA MARKETPLACE” and is hereby incorporated by reference in its entirety.

### FIELD OF THE INVENTION

The present invention relates to a data marketplace, more specifically a central hub for data assets.

### SUMMARY OF THE INVENTION

The present invention provides a system for a centralized data asset marketplace including a single network or cloud platform environment for the sharing and distribution of data assets, wherein the platform is public or private; multiple user interfaces, wherein the user interfaces include a home page, a data asset detail interface, a shopping cart interface, a user data section interface and an administrative section interface; and data assets, wherein the data assets are at least one of a report, a file download, a data service, a micro service or an applet.

The present invention also provides a method for managing data assets via a centralized system including registering of data assets, wherein the registering of the data assets includes registering meta data of the data assets; accessing and execution of data assets; searching for data assets, wherein the searching can be via a pre-configured search or custom created search queues; sharing of data assets, wherein the sharing of the data assets can be done for the corresponding meta data or of actual results of the data asset; checking out data assets, wherein checking out of the data assets includes adding the assets to a shopping cart; and authorization for selective execution of the data assets.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 shows a screen shot of the “Home Page” of the present invention;

FIG. 2 shows a screen shot of the “Data Asset Detail” screen;

FIG. 3 shows a screen shot of the “Shopping Cart” screen;

FIG. 4 shows a screen shot of the “My Data Section” screen; and

FIG. 5 shows a screen shot of the “Administrative Section for Data Assets” screen.

### DETAILED DESCRIPTION

The Data Marketplace Platform is a centralized virtual and physical hub and shopping experience for data assets. Data assets can include any digital sharing such as reports, file downloads, data services (e.g. REST), micro services, applets, etc. This present invention provides a platform that allows for the registration of, searching of, sharing of, checking out of, charging for, accessing of, execution of, scheduling of, scoring of and commenting on data assets.

Within this platform data assets can be registered which includes meta-data (e.g. name, description, connection details, attribute level data dictionary, cost, etc.). There is also a configurable tagging system to all for the ability to tag data assets in a customizable fashion with no software development. Data assets can exist anywhere and the setup includes connection details which can be a URL, file path, executable, SQL statement, function, etc. The platform also allows for the ability to categorize data assets and individual data attributes within an asset by data confidentiality/sensitivity (e.g. Confidential, Public, PII, HIPPA, etc.)

The Data Marketplace allows users of the system to search for data assets via any combination of string searches and tag value combinations. This search is able to search all of the meta data and even the data accessible via the data asset.

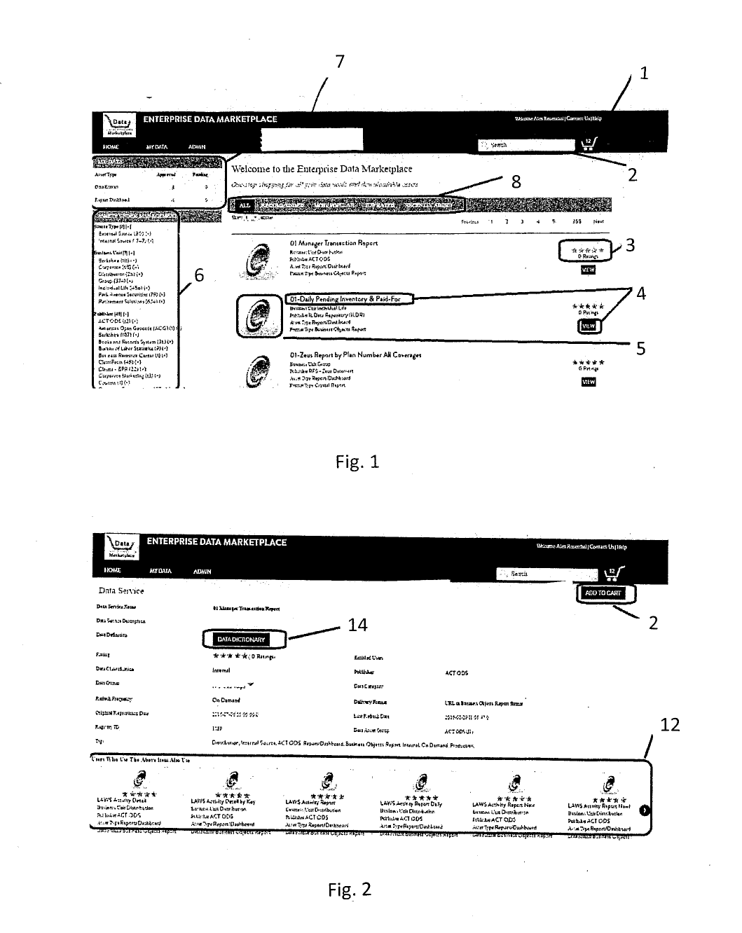

FIG. 1 shows an example of the Home Page of the present invention. The Home page provides the user with access to various information including a shopping cart 1, a search query bar 2, ratings/reviews 3, links 4, custom images 5, tagging capabilities 6, a summary 7 and a tab 8. Shopping cart 1 provides the user with ability to check-out data assets. The Search Query bar 2 provides the user with the ability to perform a search through all the data and meta data. Rating/reviews 3 are provided for the data assets and allow the community/users to provide feedback sharing regarding the usefulness of the data asset. Links 4 allow the user to drilldown into a further detailed view of the data asset. Image 5 allows the user to easily distinguish between different publisher source systems. Tagging 6 provides searchable custom tagging capabilities to profile data assets. Summary 7 provides a summary of the data assets entitled to the user. Tab 8 is a sub tab of the search queue to show data assets to the user.

There are pre-configured searches including: “Most Popular”, “Most Utilized”, “Recommended for Me.” And “Recently Added.” The “Most Popular” search is determined by the measurement of entitled users/applications. The “Most Utilized” search is determined by measurement of user/application usage patterns. The “Recommended for Me” search is determined by profiling users accessing the system and recommending data assets that are related to data assets they have searched for, viewed, or accessed. It also includes profiling off of user characteristics, such as department, geographical location, etc., for example. The “Recently Added” search displays data assets that were most recently published on the data marketplace for searching or consumption.

In addition to the pre-configured searches, the platform allows for other configured search queues to be created at a user level, regional level or platform level.

FIG. 2 shows a screen shot of the Data Asset Detail Screen. This screen includes shopping cart 2, display 12 and button 14. Shopping cart 2 provides the user with the ability to add the data asset to the shopping cart for checkout. Display 12 provides a display of other data assets that may be of interest to the user based on the current data asset being viewed. Button 14 allows the user to access data dictionary details for a data asset.

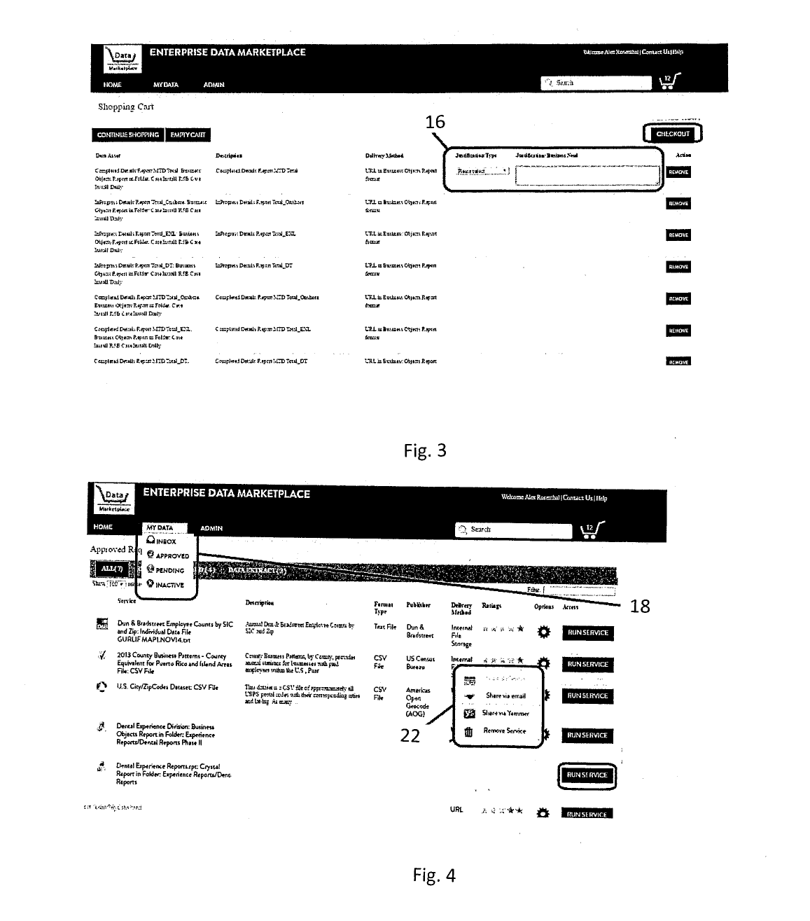

FIG. 3 shows a screen shot of the Shopping Cart screen that includes prompt 16. Prompt 16 prompts the user to justify the need for the data asset they are requesting.

FIG. 4 shows a screenshot of the “My Data Section” screen. This screen in the data marketplace includes a dropdown menu 18 allowing the user to view their “In Box,” “Approved Data Asset,” “Pending Data Assets,” “Rejected Data Assets,” and “Inactive Data Assets.” The “In Box” is where data asset results can be delivered to, by, or for a user. The “Approved Data Asset” is a central listing of all data assets a user is entitled to access/execute. This is important as it becomes the one stop location for all data assets a person or application resource can go to perform their daily functions. The “Pending Data Assets” displays all data assets that have been requested/checked-out by a user, but not yet fully approved within the approval process. The “Rejected Data Assets” displays all data assets that have been requested/checked-out by a user, but was rejected within the approval process. The “Inactive Data Assets” displays all data assets that were deleted by the user after they were entitled to them. This can also include data assets where the user's data access rights have expired. Other functionality provided include menu 22 which allows the user to schedule a data asset to run, share the details about a data asset with others via email, Yammer or other social media communication, or remove the service when it is no longer needed. The User is also able to run the service immediately.

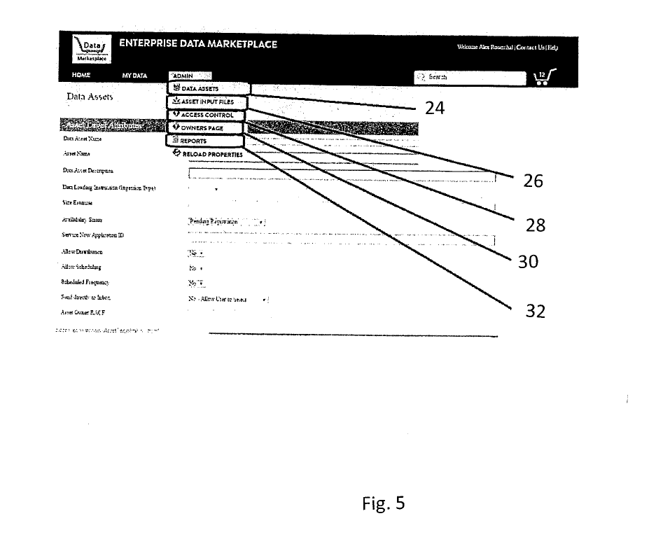

There are administrative related screens and features which include: “Data Asset Admin,” and the “Owner Screen.” FIG. 5 shows a screen shot of the Administrative Section screen, “Data Asset Admin,” where data assets are created, updated and deleted. This includes the meta data and even the underlying data asset. For example, where the asset is a file that has been uploaded for consumption by others. The “Owner Screen” allows the owner of data assets to actively monitor and manage the usage and entitlements of data assets. This includes an attestation workflow. Included in the Admin menu are headers for assets 24, inputting files 26, access control 28, an owners page 30 and reports 32. Assets 24 allows admin entitled users to create new data assets manually. This can also read the meta data from other tools to register assets as well, for example, business objects. Input files 26 provides the ability for an entitled user to upload data assets or driver files for data assets to run. Access control 28 provides the ability to manage entitlements as an administrator. Owners page 30 provides the ability for owners of data assets to manage their data assets meta data setup and entitlements and support attestation requirements. Reports 32 provides the ability to create and run canned and ad hoc reports to administer the platform.

The sharing of data assets within the Data Marketplace can be done for the corresponding meta data or the actual results of a data asset. This sharing can be done via the platform's internal notifications, email, text message and/or social network.

The checking out of a data assets include the adding of assets to a shopping cart. Data assets can be free or can be charged for. The check-out approval process can be configurable at a service level to reflect the cost or the sensitivity of the data/functionality of the data asset. For example, if a data asset has HIPPA or Pll data, the checkout and approval process require the approval of many individuals such as a person's manager, the data asset owner, compliance and legal officers, etc. The accessing of data assets can be free or at a cost. The cost can be time based, execution based, data size based, etc.

The accessing and execution of data assets can either be via the data marketplace interface or directly to the data asset itself. The data marketplace manages entitlements and can share these entitlements with other systems. The data marketplace can also access external authorization/authentication systems (e.g. LDAP, etc.). Depending on the type of data asset, the data marketplace can be the owner/host of a data asset or it can be a pass through to data assets where they reside. For example, a data asset can be a full blown function managed by the platform or it can be as simple as a URL link to a 3^{rd} party web site.

Data assets can be scheduled to be executed by a user or by a central administrator. This includes the setup of a schedule by time or by a data condition. The schedule can include the designation of different data distribution methods such as, Data Marketplace Inbox, email, ftp, etc. It can also be distributed to zero, one or many recipients.

Data assets can be scored and commented on by users in order to provide a community and socialization around the usage, quality, etc. of the data assets. This allows for a better actively managed experience for users determining what assets are useful or not. Users who navigate the data marketplace can also see who the owner of a data asset is and be able to contact them for more information. There is also the ability to see what other users have access to the data asset and when they last accessed the asset.

The Data Marketplace can be hosted within a single network or can be deployed to cloud platform environments. The install can be specific to one or a grouping of people and/or organizations. It can be available as a public or private platform for the sharing and distribution of data assets.

Although the present invention has been described in conjunction with specific embodiments, those of ordinary skill in the art will appreciate the modifications and variations that can be made without departing from the scope and the spirit of the present invention.

1. A system for a centralized data asset marketplace comprising:
a single network or cloud platform environment for the sharing and distribution of data assets, wherein the platform is public or private;
multiple user interfaces, wherein the user interfaces include a home page, a data asset detail interface, a shopping cart interface, a user data section interface and an administrative section interface; and
data assets, wherein the data assets are at least one of a report, a file download, a data service, a micro service or an applet.

2. A method for managing data assets via a centralized system comprising:
registering of data assets, wherein the registering of the data assets includes registering meta data of the data assets;
accessing and execution of data assets;
searching for data assets, wherein the searching can be via a pre-configured search or custom created search queues;
sharing of data assets, wherein the sharing of the data assets can be done for the corresponding meta data or of actual results of the data asset;
checking out data assets, wherein checking out of the data assets includes adding the assets to a shopping cart; and
authorization for selective execution of the data assets.

3. The method as recited in claim 2 further comprising charging for the access and execution of the data assets.

4. The method as recited in claim 2 further comprising scheduling of the data assets, wherein the scheduling includes a setup for execution by time or by a data condition;

5. The method as recited in claim 2 further comprising categorizing the data assets.

6. The method as recited in claim 2 further comprising scoring of the data assets.

7. The method as recited in claim 2 further comprising commenting on the data assets.

8. The method as recited in claim 2 wherein the authorization of selective execution includes accessing external authorization/authentication systems.
